(19) United States
(12) Patent Application Publication
(10) Pub. No.: US 2024/0121588 A1
(43) Pub. Date: Apr. 11, 2024

(54) OPTIMIZED DEREGISTRATION OF USER EQUIPMENT

(71) Applicant: Hewlett Packard Enterprise Development LP, Houston, TX (US)

(72) Inventors: LU TIAN, Plano, TX (US); Anders Askerup, Plano, TX (US); David C. Williamson, Plano, TX (US); John I. Ayers, Omaha, NE (US)

(21) Appl. No.: 17/962,913

(22) Filed: Oct. 10, 2022

(51) Int. Cl. H04W 8/04; H04W 60/04; H04W 60/06

(52) U.S. Cl. CPC H04W 8/04; H04W 60/04; H04W 60/06

(57) ABSTRACT

The systems and method disclosed herein optimize the deregistration of user equipment (UE) from the 5GC. For example, when the UE operates in single-registration mode, for AMF 3GPP access registration with drFlag attribute set to false (or to be absent) in UDM/UDR, a “new attribute”, singleRegIndication, is defined. The AMF sets the singleRegIndication value to “NO_INDICATION” when there is no N26 interface connection to MME. UDM will not instruct HSS to cancel MME (and SGSN/VLR) if there is an old AMF 3GPP registration for which “NO_INDICATION” or “DEREGISTER_SN” is set as the singleRegIndication value (i.e. the old AMF was already registered with the single registration). Otherwise, the AMF sets the singleRegIndication value to “DEREGISTER_SN” when the AMF has established a N26 interface connection to the old MME. UDM can instruct HSS to cancel the MME (and SGSN/VLR).

### BACKGROUND

Wireless devices (e.g., smart phones, tablets, and laptops) are used to send and receive data. Such data may be transmitted and received over a wireless network. The 5^{th} Generation (5G) is a standard promulgated by the International Telecommunication Union (ITU) and the 3rd Generation Partnership Project (3GPP), with the ITU setting the minimum requirements for 5G compliance, and the 3GPP creating the corresponding specifications. 5G is a successor to the 4G/Long Term Evolution (LTE) standard, and refers to the fifth generation of wireless broadband technology for digital cellular networks. 5G is intended to replace or augment 4G/LTE. Touted advantages of 5G include, e.g., exponentially faster data download and upload speeds, along with much-reduced latency (also referred to as “air latency”, e.g., the time it takes for a device to communicate with the network).

The frequency spectrum of 5G includes three bands. The first band can be referred to as the low-band spectrum, i.e., the sub-1 GHz spectrum. This low-band spectrum is the primary band used by U.S. wireless carriers with data speeds reaching about 100 Mbps. The second band can be referred to as the mid-band spectrum, i.e., the sub-6 GHz spectrum, which provides lower latency (e.g., 4-5 ms) and greater data speeds (e.g., up to 1 Gbps) relative to the low-band spectrum. However, mid-band signals are not able to penetrate structures, such as buildings, as effectively as low-band signals. The third band can be referred to as the high-band spectrum, or millimeter wave (mmWave), and operates between 25 GHz and 100 GHz. The term millimeter is associated with this high-band spectrum because wavelengths in this portion of the spectrum range from, e.g., 1-10 mm. Devices operating on this third band can deliver the highest data speed (e.g., up to 10 Gbps) and the lowest latency (e.g., 1 ms). However, its coverage area (the distance it can transfer data) is less than that of the low-band and mid-band spectrums, due in part to poor building penetration. Use of mmWave technology may however, avoid already congested portions of the spectrum. So long as the limited coverage area is acceptable, the benefits of mmWave technology can still be realized.

5G coverage to provide services to users from any physical location requires deployment of 5G cells that provide full coverage. However, currently 5G has been partially deployed, resulting in coverage holes. Thus, 5G provides for interworking with the existing 4G/LTE cellular networks that enables user equipment (UE) mobility between 5G and 4G/LTE cellular networks as UEs move into and out of 5G coverage areas.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example cellular communication system.

FIG. 2 illustrates an example message flow diagram reflecting operations performed to effectuate deregistration of user equipment from a core network.

FIG. 3 illustrates an example message flow diagram reflecting operations with a UE operating in a single registration mode with the use of the N26 interface, in accordance with some examples of the application.

FIG. 4 illustrates an example message flow diagram reflecting operations with a UE moving from a first location to a second location and operating in a single registration mode with the use of the N26 interface, in accordance with some examples of the application.

FIG. 5 illustrates an example message flow diagram reflecting operations with a UE moving from a first location operating in a dual registration mode to a second location operating in a single registration mode with the use of the N26 interface, in accordance with some examples of the application.

FIG. 6 is an example computing component that may be used to implement various features of user equipment deregistration in accordance with the implementations disclosed herein.

The figures are not exhaustive and do not limit the present disclosure to the precise form disclosed.

### DETAILED DESCRIPTION

A mobile network can be thought of as comprising two component networks, the radio access network (RAN) and the core network. In 5G cellular networking systems these components are a 5G access network (5G-AN) and a 5G core network (5GC) and in 4G/LTE cellular networking systems these components are radio access network (RAN) and an Evolved Packet Core Network (EPC). The 5GC may include various virtualized network functions (NFs), including, for example, Core Access and Mobility Management Function (AMF) in communication with a Unified Data Manager (UDM). The AMF is configured to handle connection and mobility management tasks. The UDM is configured to manage user authentication, authorization, and device registration on the 5GC. The EPC may include its own NFs, including, for example, a Mobility Management Entity (MME) in communication with a Home Subscriber Server (HSS). The MME provides connection management functionality between UEs and the EPC. NFs may be implemented as one or more network devices or apparatuses.

As noted above, 5G provides for interworking with the existing 4G/LTE networks providing, among other functionality, for mobility of UEs between the 5GC and the EPC. 5G and 4G/LTE are generally mutually exclusive, such that a UE may not be attached to the EPC and the 5GC at the same time (except where the networking function of the EPC is set for dual registration), since these correspond with two types of telecommunication networks. In case that the networks are mutually exclusive, the 4G/LTE does not have access to 5GC attachment status of the UEs on attached to the EPC. Accordingly, in the case of migration of services from the 5GC to the EPC, the EPC can notify the 5GC that a UE is attached to the EPC and instruct the 5GC to deregister the UE and cancel 5G services (e.g., using a cancel-location-request or CLR). For example, when a UE attempts to attach to the EPC, the MME serving the UE initiates a registration call flow to attach the UE to the EPC for 4G/LTE services. This call flow includes, among other functions and operations, requesting registration with the EPC. Responsive to the registration request, the MME issues an Updated Location Request (ULR) to the HSS, which may then inject a deregistration instruction into the 5GC. The deregistration instruction is provided to the UDM and delivered to the AMF. The AMF then deregisters the UE from the 5G cellular network, thereby cancelling 5G services rendered thereto. This deregistration process can be improved, as discussed herein.

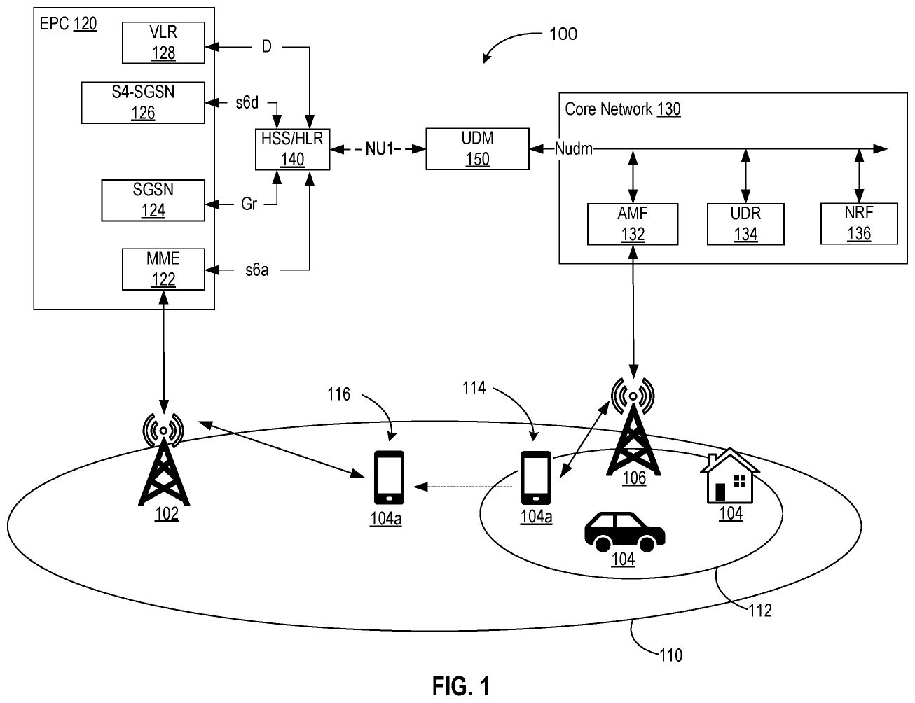

Before describing the details of the various implementations disclosed herein, it would be beneficial to describe an example cellular network to which the aforementioned UE may register and deregister. FIG. 1 illustrates an example cellular communication system 100 with which various implementations of the present disclosure may be implemented. The cellular communications system may comprise a plurality of base stations or cells (e.g., base stations 102 and 106), user equipment (UE) 104, an Evolved Packet Core (EPC) 120, and another core network 130 (e.g., a 5GC) operating on different types of telecommunications networks. The base stations 102 may include macrocells (high power cellular base station) and/or small cells (low power cellular base station).

In the illustrative example of FIG. 1, base station 102 is configured according to 4G/LTE standards and interfaces with the EPC 120 through an S1 interface. Base station 106 is configured according to 5G standards and interfaces with core network 130 through an N1/N2 interface. The base stations 102 and 106 may wirelessly communicate with one or more UEs 104. Each of the base stations 102 and 106 may provide communication coverage for a respective geographic coverage area 110 and 112, respectively. There may be overlapping geographic coverage areas. For example, the base station 102 may have a coverage area 110 that overlaps the coverage area 112 of one or more other base stations, such as base station 106 as shown.

While a single base station 102 (e.g., a 4G/LTE configured base station) and a single base station 106 (e.g., a 5G configured base station) are illustrated, the cellular communication systems disclosed herein are not limited thereto. One or more base stations 102 and/or one or more base stations 106 may be provided. For example, a plurality of base stations 102 may be provided, each having a respective coverage area 110. One or more of the respective coverage areas 110 may overlap. Similarly, a plurality of base stations 106 may be provided, each having a respective coverage area 112. One or more of the respective coverage areas 112 may overlap. Furthermore, one or more coverage areas 110 may overlap with one or more coverage areas 112.

Base stations 102 and 106 may include an eNB, gNodeB (gNB), or another type of base station. Some base stations, such as base station 106, may operate in the frequency spectrum of 5G, including the low-band spectrum, i.e., the sub-1 GHz spectrum; the mid-band spectrum, i.e., the sub-6 GHz spectrum; and/or the high-band spectrum, e.g., millimeter wave (mmWave) that operates between 25 GHz and 100 GHz.

EPC 120 includes various network function entities, including, for example but not limited to, one or more Mobility Management Entity (MME) or Mobility Management Device (MMD) 122 (used interchangeably), a Serving Gateway (S-GW) (not shown), a Packet Data Network (PDN) Gateway (not shown), among other network function entities. Although MME or MMD 122 is illustrated in FIG. 1, this device may correspond with any type of mobility management device, including a Serving General Packet Radio Service (GPRS) Support Node (SGSN), a S4-SGSN, and a Visitor Location Register in various examples, and these terms are used interchangeably throughout the disclosure.

Each MME 122 may be in communication with a Home Subscriber Server (HSS) 140 over a designated interface, for example, a s6a interface used for exchange of authentication, location, and server information about subscribers between the HSS 140 and MME 122. Each MME 122 may function as a control node that processes signaling between the UEs 104 and the EPC 120, including providing bearer and connection management functionality. The Packet Data Network (PDN) Gateway may be connected to IP Services, such as the Internet, an intranet, an IP Multimedia Subsystem (IMS), a Packet-Switched (PS) Streaming Service, and/or other IP services.

The NFs of EPC 120 may be implemented as computing systems, such as one or more servers. The NFs of the EPC 120 may communicate using protocols, such as the Diameter Protocol and/or Mobile Application Part (MAP) of the SS7 protocol. For example, the Diameter Protocol may be used for messages between the MME and the HSS or an S4-SGSN and the HSS, while MAP may be used for messages between a Home Location Repository (HLR) and a SGSN or VLR. Data included in the messages on the EPC may be formatted according to American Standard Code for Information Interchange (ASCII) protocols.

Core network 130 may include various virtualized network functions (NFs), including, for example but not limited to, an Authentication Server Function (AUSF) (not shown), Core Access and Mobility Management Function (AMF) 132, a policy control function (PCF) (not shown), a session management function (SMF) (not shown), a Unified Data Repository (UDR) 134, and a Network Repository Function (NRF) 136, to name a few. For example, AMF 132 may be the control node that processes the signaling between UEs 104, via base station 106 and core network 130.

AMF 132 may receive connection and mobility management tasks from UEs 104 and can handle connection and mobility management tasks, while forwarding session management tasks/messages to a Session Management Function (SMF). AMF 132 may be in communication with UDM 150 over a service-based interface (SBI) for UDM 150, such as a Nudm interface.

Core network 130 may also include NRF 136, which provides for network function service registration, authorization, and discovery, and otherwise enables network functions to identity one another. Core network 130 may also include a User Plane Function (UPF) (not shown) that is connected to IP Services, which may include the Internet, an intranet, an IMS, a PS Streaming Service, and/or other IP services.

The NFs of core network 130 may be implemented as computing systems, such as one or more servers. The NFs of core network 130 may communicate using protocols, such as HyperText Transfer Protocol (HTTP). Communications and operations may be sent, for example, using HTTP methods, such as POST, PATCH, GET, PUT, etc.

As noted herein, AMF 132 may receive connection and session-related information from UEs across N1/N2 reference point interfaces (between UE and AMF/between RAN and AMF), but may handle connection and mobility management tasks. That is, an AMF instance may be specified by a UE, e.g., UE 104, in a Non-Access Stratum (NAS) message that is routed to the AMF instance by the RAN. Performing the role of an access point to the 5G core network (terminating the RAN control plane and UE traffic), the AMF instance may authenticate the UE and manage, e.g., handovers, for the UE between access points, base stations, and gNBs.

UDM 150 provides services to other functions of the Service-Based Architecture (SBA), such as AMF 132 and other network functions. UDM 150 may store information in local memory. UDM 150 may also store information externally, for example, within UDR 134. UDM 150 may provide authentication credentials while being employed by AMF 132 to retrieve subscriber data and access registration context data.

Although the preceding description may provide examples based on 5GC and 4G/LTE, it should be appreciated that the concepts described therein may be applicable to other types of telecommunication networks. For example, the concepts described herein may be applicable to legacy networks, such as, GPRS, CDMA, GSM, and/or other wireless technologies in which a UE may operate. For example, EPC 120 may include network functions of the legacy types of telecommunication networks. GPRS core networks included a SGSN configured to perform functions similar to MME 122. EPC 120 may include or be communicably coupled to a SGSN 124 that communicates with the HSS 140 via a designated interface, such as, a Gr interface for routing information between the SGSN 124 and the HSS/HLR 140. In some GPRS core networks, an S4-SGSN is used for performing functions similar to MME 122. EPC 120 may include or be communicably coupled to a S4-SGSN 126 that communicates with HSS 140 via a designated interface, such as, a s6d interface used for exchange of authentication, location, and server information about subscribers between HSS 140 and S4-SGSN 126. GSM core networks include a Visitor Location Register (VLR) configured to perform functions similar to the MME 122 and a HLR performing functions similar to HSS 140. EPC 120 may include or be communicably coupled to VLR 128 that communicates with HSS 140 via a designated interface, such as a D interface used for routing information between a VLR 128 and the HSS/HLR 140.

The term “mobility management entity” (MME) or “mobility management device” (MMD) can be used herein to refer to one or more of an MME, SGSN, S4-SGSN, VLR, or similar network function entity included in the EPC, while “legacy mobility management device” will be used herein to refer to one or more of SGSN, S4-SGSN, VLR and the like. Additionally, “location and service information interface” may be used to refer to one or more of the s6a, s6d, D, Gr, or similar interfaces between the HSS and a respective mobility management device.

Base stations 102 and/or 106 may provide an access point to EPC 120 or core network 130 for UE 104. Examples of UEs 104 include cellular phones, smart phones, laptop computers, tablet computers, personal computers, vehicle-implemented communication devices (e.g., vehicles having vehicle-to-vehicle (V2V) capabilities), multimedia devices, game consoles, wearable devices, or any other similar functioning device. Some of UEs 104 may be referred to as IoT devices (e.g., parking meter, gas pump, toaster, vehicles, heart monitor, etc.). Each UE may move about the cellular network system 100 into and out of respective coverages areas (e.g., coverage area 110 and 112).

As noted herein, 5G provides for interworking with the existing EPC providing for mobility of UEs between 5G and 4G/LTE, for example, or other types of telecommunication networks. Accordingly, 5G provides for service migration by attaching to and from each network as the UE moves into and out of coverage areas. Thus, interworking between the networks allows for migration of attachment between the 5GC and EPC through communication between UDM 150 and HSS 140 via a NU1 interface.

For example, as shown in FIG. 1, UE 104a (illustrative depicted as a mobile smartphone) moves from first position 114, in coverage area 112, to second position 116, out of coverage area 112, as shown by the dotted arrow. If UE 104a is capable of receiving 5G services, while present in coverage area 112, UE 104a may be registered with and attached to AMF 132. Upon moving out of coverage area 112 to the 4G coverage area 110, UE 104a will attempt to attach to EPC 120 via a registration request to the MME 122. Once registered and attached to MME 122, UE 104a is able to receive 4g/LTE services via EPC 120.

An interworking facilitates the transition between networks to ensure that seamless transition is achieved. For 5G and EPC interworking, there are generally two solutions: single registration solution and dual registration solution. With the single registration, the UE 104a is permitted to attach to one of the EPC or 5G telecommunication networks at any point in time. Accordingly, a deregistration of the other telecommunication network may be exchanged through a control interface between the telecommunication networks, for example, between HSS 140 to UDM 150 over a NU1 interface when the attachment status of UE 104a is updated. With dual registration, UE 104a may be registered to both the EPC or 5GC telecommunication networks at any point in time, and thus there is no deregistration instruction transmitted as an electronic communication or message between the HSS and the UDM.

As an illustrative example, FIG. 1 shows UE 104a at first position 114, at which point the UE 104a is registered with AMF 132 for receiving 5G services. When UE 104a moves to second position 116, UE 104a moves out of the 5G coverage area 112 and needs to attach to EPC 120 to receive 4G/LTE services, which allows UE 104a to move from a first type of telecommunication network to a second type of telecommunication network. To do so, UE 104a issues a registration request to a MMD of EPC 120 and the MMD sends an update location request (ULR) to the HSS 120, via a respective location and service information interface. For example, an Update Location Request is transmitted according to the Diameter Protocol and an Update Location is transmitted according to the MPA protocol. The term “update location request” or “ULR” will be used herein to refer to an Update Location Request sent under the Diameter protocol and/or an Update Location sent under the MAP protocol. HSS 120 checks subscriber data to confirm UE 104a is permitted to attach to EPC 120 and other subscription information and, if so, issues an Update Location Answer to the mobility management device. Based on the Update Location Answer, UE 104a is registered with and attached to the MMD for rendering of services in the 4G/LTE telecommunication network.

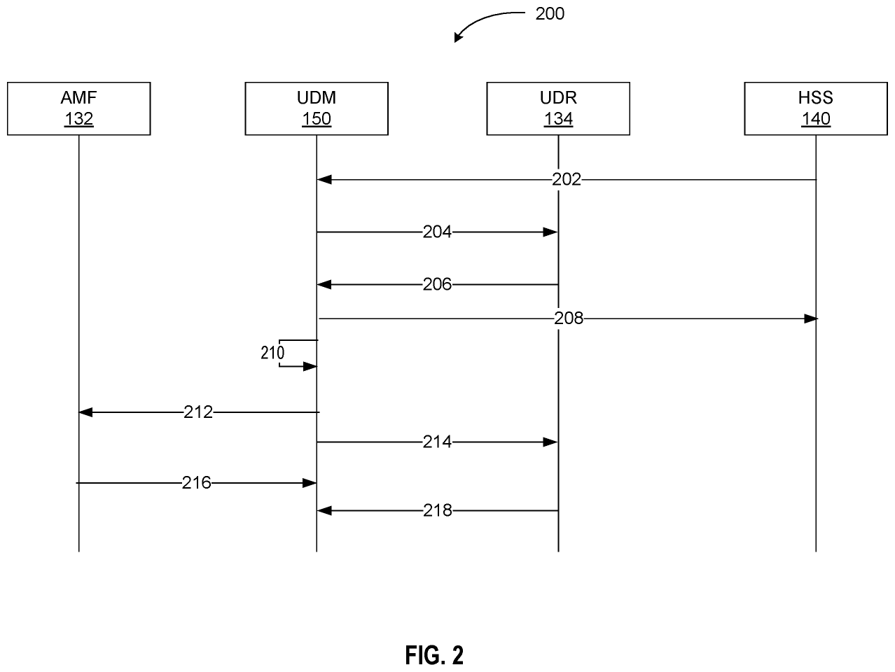

The ULR includes an indicator, for example, Dual-Registration-5G-Indicator bit 8 in the ULR-Flag attributed-value pair (AVP), that notifies HSS 140 as to whether or not the MMD is configured for dual registration in two types of telecommunication networks. When the MMD is not configured for dual registration, this indicator in the ULR is set to 0. Upon receipt of the ULR from the MMD, HSS 140 transmits a deregistration instruction (e.g., Nudm_UECM_Derreg-amf) to UDM 150 which delivers the deregistration notification to the registered AMF 132 (if any). Receipt of the deregistration notification may trigger the receiving AMF 132 to deregister UE 104a due to mobility from core network 130 to EPC 120. An example of this exchange is illustrated in connection with FIG. 2, below. According to various implementations disclosed herein, if the MMD is configured for dual registration, upon receipt of the ULR from the MMD, the HSS 140 does not transmit the deregistration instruction since registration with both the EPC 120 and core network 130 (or other two types of telecommunication networks) is permissible.

FIG. 2 illustrates an example message flow diagram reflecting operations performed to effectuate deregistration of an UE operating in the single registration mode from the core network 130. With reference to FIG. 1 and message flow 200 of FIG. 2, HSS 140 may transmit a deregistration instruction to the UDM 150 with message 202, for example, over the NU1 interface. The message 202 may also include an identification of the UE (also referred to as “ueld”) to be deregistered, for example, a subscription identifier (e.g., an international mobile subscriber identity (IMSI) for the UE). An example deregistration instruction may provide as instruction or operation “{ueld}/registrations/amf-3gpp-access/dereg-amf” and mapped or otherwise associated with the HTTP method “POST”.

Through message 204 and in response to message 202, UDM 150 retrieves a current AMF access registration context data stored in UDR 134 corresponding to the UE identified by message 202. That is, UDM 150 may use the ueld extracted from message 202 to retrieve a corresponding AMF access registration context data for the identified UE. For example, UDM 150 may provide operation “subscription-data/{ueld}/context data/amf-3gpp-access” mapped to HTTP method “GET” to UDR 134. UDR 134 responds to UDM 150 with message 206, which includes the requested AMF access registration context data. UDM 150 may then respond to the HSS 140 with message 208 confirming receipt of message 202, for example, using HTTP status code 204 acknowledging receipt and service response.

At 210, UDM 150 checks the current AMF access registration context data for a purge flag. The purge flag indicates whether or not the AMF has deregistered the UE. If the purge flag is absent from the AMF access registration context data or set to false, UDM 150 sends the deregistration notification to AMF 132 with message 212. For example, UDM 150 uses a callbackReference Uniform Resource Locator (URL) in the AMF access registration context data to provide the AMF deregistration notification Nudm_UECM_DeregistrationNotification with HTTP method “POST” to AMF 132. Prior to sending message 212, UDM 150 sets a deregistration reason attribute in the deregistration notification to: (1) “5GS_TO_EPS_MOBILITY_UE_INITIAL_REGISTRATION”, in the case that “UE_INITIAL_REGISTRATION” was received in the deregistration instruction from the HSS 140; or (2) “5GS_TO_EPS_MOBILITY”, in a case that “5GS_TO_EPS_MOBILITY” or an unexpected reason is received in the deregistration instruction from HSS 140.

When “UE_INITIAL_REGISTRATION” is sent by HSS 140, it indicates that the deregistration towards UDM 150 is due to an initial attach in EPC 120. “5GS_TO_EPS_MOBILITY_UE_INITIAL_REGISTRATION” indicates that the deregistration in the AMF 132 is due to an initial attach in the EPC 120. “5GS_TO_EPS_MOBILITY” indicates that the deregistration is due to non-initial attach to the EPC 120.

UDM 150 also sets the purge flag in the access registration context data to true and updates access registration context data stored the UDR 134 with message 214. For example, the UDM 150 issues message 214 including operation subscription-data/{ueld}/context-data/amf-3gpp-access (purgeFlag) mapped to the HTTP method “PATCH”. In another example, UDM 150 may map the operation to HTTP method “PUT” to replace the data with the updated data. While FIG. 2 illustrates message 212 sent prior to message 214, the temporal relationship of these messages are not limited thereto. Message 212 may be transmitted after or at the same time as message 214. The AMF 132 and UDR 134 may respond with to UDM 150 confirming completion with message 216 and 218, respectively.

In the case that UDM 150 determines the purge flag is set to true at 210, the flow does not execute message 212 to 214 since the UE has already been deregistered from AMF 132. Additionally, message 208 may be transmitted at any point in the message flow after message 206, for example, after message 218.

In the event that access registration context data does not exist in UDR 134, UDM 150 receives an indication of such (e.g., HTTP status code 404/USER_NOT_Found or DATA_NOT_FOUND) in message 206 from UDR 134. UDM 150 then forwards the indication to HSS 140 as message 208.

The messages 204-218 of message flow 200 are executed at the core network 130 each time a deregistration instruction is received at UDM 150. Under either the single or dual registration solution, a UE may move between multiple MMDs of the EPC, and each changeover could result in a repetitive and unnecessary deregistration instructions receive at UDM 150. For example, UE 104a may migrate from core network 130 to EPC 120 (e.g., two types of telecommunications networks) and register with MME 122. Registration with MME 122 results in a deregistration instruction issued to UDM 150 and execution of the message flow 200. Then, at a later point in time, the UE 104a may register with one or more of the SGSN 124, S4-SGSN 126, and/or VLR 128, and each registration may result in a corresponding deregistration instruction sent from the EPC 120 to core network 130 (e.g., two types of telecommunications networks). These subsequent deregistration instructions are repetitive of the first deregistration instruction since the AMF 132 has already deregistered the UE 104a and cancelled core network 130 services. Each redundant deregistration instruction uses computation resources and cycle burns at the core network 130 to process and respond to, thereby consuming resources that could be used for other core network functions.

As discussed herein, the single registration and dual registration processes generate and transmit different messaging from each other. For example, in single registration, the receipt of the deregistration notification triggers the receiving AMF 132 to deregister UE 104a due to mobility from core network 130 to EPC 120. In dual registration, HSS 140 does not transmit the deregistration instruction since registration with both the EPC 120 and core network 130 is permissible. However, the single registration process continues to result in the transmission of multiple deregistration instructions between the HSS and the UDM during the AMF-to-AMF mobility and during the MME-to-MME mobility. Implementations disclosed herein provide for systems and methods that optimize the deregistration of UEs by reducing the number of message transmissions and creating less traffic in the network.

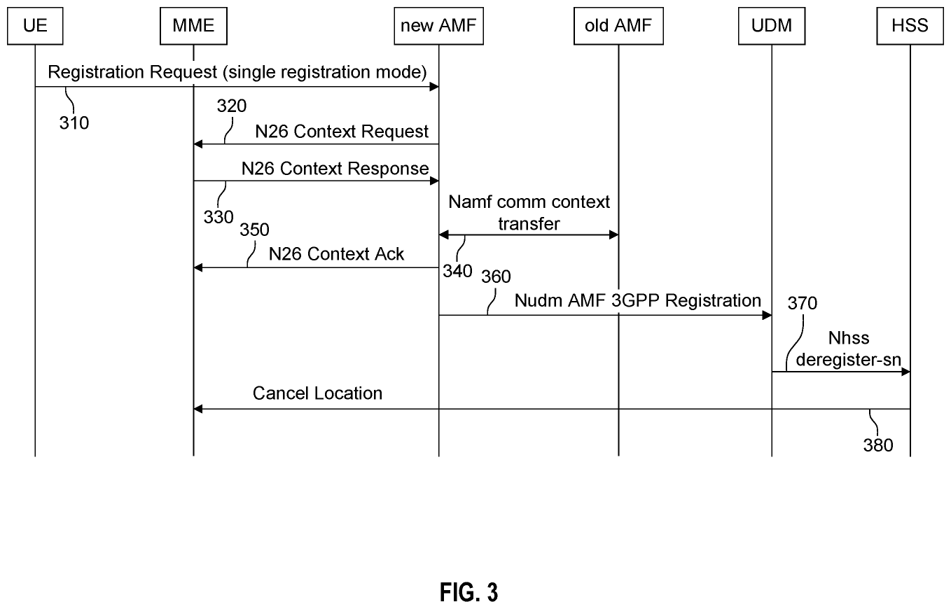

An illustrative process of a UE operating in a single registration mode in 5GC with the use of the N26 interface is illustrated in FIG. 3. The devices illustrated in FIG. 3 may be substantially similar to the devices illustrated in FIG. 1 and discussed throughout the disclosure, including UE 104, MME 122, AMF 132, UDM 150, and HSS 140.

At block 310, the UE transmits a registration request communication to new AMF. The contents of the registration request communication may be defined in the 3GPP specification. For example, the registration request communication can comprise a registration type; SUCI or 5G-GUTI or PEI; Security parameters; additional GUTI; 4G Tracking Area Update; the indication that the UE is moving from EPS; PLMN with Disaster Condition; and, if the UE is registering with an SNPN, the NID of the SNPN that assigned the 5G-GUTI. In response to the new registration request, the new AMF can transmit a communication to the UDM to identify the new registration.

At block 320, the new AMF transmits a context request communication to MME via the N26 interface. For example, the context request to the MME may include EPS GUTI mapped from 5G-GUTI and the TAU request message according to TS 23.401. In some examples, the MME may validate the TAU message.

At block 330, the MME transmits a context response communication to new AMF via the N26 interface. For example, the MME can include EPS MM Context, IMSI, ME Identity, UE EPS security context, UE Network Capability, and EPS Bearer context(s) in the Context Response message and sends to the AMF.

At block 340, the new AMF and old AMF transmit communications between each other including the Namf comm context transfer (e.g., the UEContextTransfer service operation) using the POST command.

At block 350, the new AMF transmits a context acknowledgement communication to MME via the N26 interface. For example, the context acknowledgement communication can include the serving gateway has changed or acknowledge another change in the communication path.

At block 360, the new AMF transmits a Nudm AMF 3GPP registration communication to UDM. For example, the request can contain the UE's identity (/{ueld}) which can be a SUPI and the AMF Registration Information for 3GPP access, in accordance with the 3GPP standard.

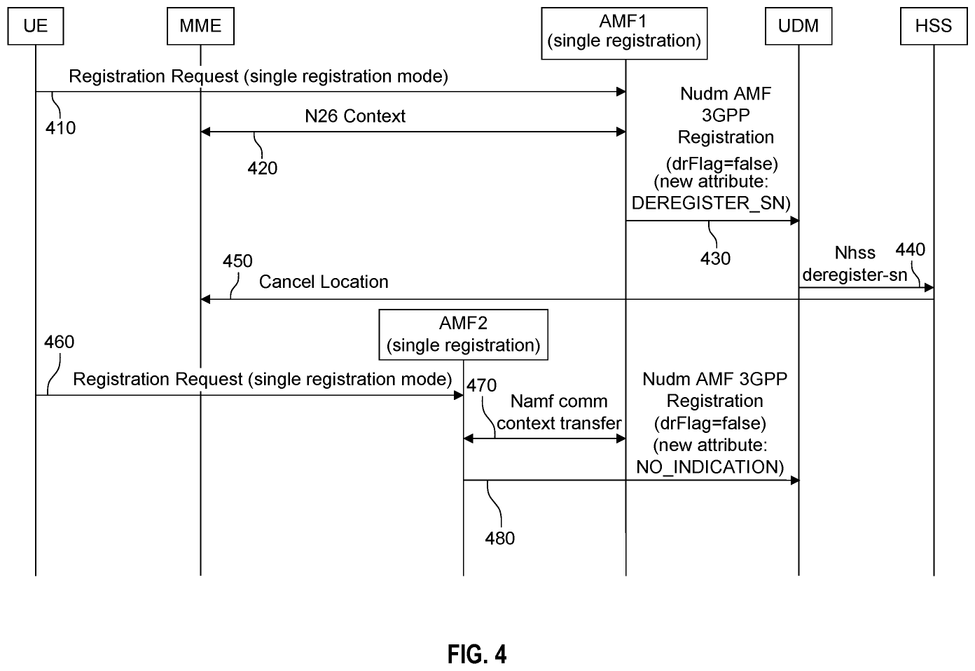

At block 370, the UDM transmits a deregistration instruction to HSS. In some examples, the deregistration instruction is an electronic communication or message that comprises an instruction between UDM and HSS to deregister the UE. Examples of the deregistration instruction may include “deregister-sn” from UDM to HSS or “dereg-amf”from HSS to UDM. In some instances, using this deregistration instruction (e.g., deregister-sn), the UDM instructs the HSS to cancel the MME, or for example, the HSS instructs the UDM to deregister the AMF (e.g., dereg-amf). In comparison, the term “deregistration notification” may correspond with the message or communication from UDM to AMF. Additional information associated with the deregistration notification is provided with FIG. 4 herein.

At block 380, the HSS transmits a cancel location communication to MME. For example, the cancel location communication can correspond with a Cancel Location Request (CLR) with a Cancellation-Type of MME_UPDATE_PROCEDURE to the previous MME (if any) and replace the stored MME-Identity with the received value. In some examples, the HSS can reset the “UE purged in MME” flag and delete any stored last known MME location information of the (no longer) purged UE.

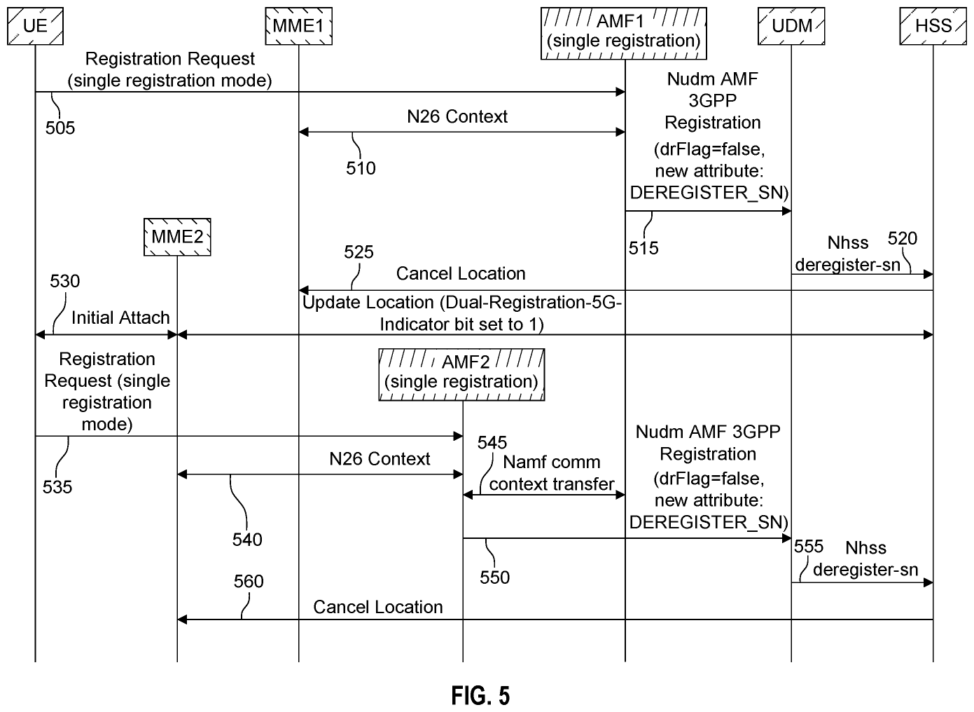

Additional deregistration processes are shown in FIG. 4 and FIG. 5, to help illustrate a UE moving from a first location to a second location in various types of telecommunication networks. The devices illustrated in FIG. 4 and FIG. 5 may be substantially similar to the devices illustrated in FIG. 1 and discussed throughout the disclosure, including UE 104, MME 122, AMF 132, UDM 150, and HSS 140. For example, the deregistration process illustrated with FIG. 3 may correspond with technical inefficiencies (although it may be beneficial in some circumstances) that may be remedied in the deregistration process illustrated in FIG. 4. For example, as a UE moves about the 4G/LTE cellular network, the UE may attach to different MMEs and legacy MMDs (e.g., Serving General Packet Radio Service (GPRS) Support Node (SGSN), Visitor Location Register (VLR), etc.). Although current 5G and 4G/LTE network systems provide for the above mobility therebetween, the current systems generate deregistration instructions corresponding to each attachment within the 4G/LTE, as illustrated in FIG. 3.

In some examples, this movement results in numerous, redundant deregistration instructions that are transmitted with 5G network traffic, regardless of the UEs attachment status with the 5GC. For example, a UE may register with an MME, resulting in a first, initial deregistration notification message injected into the 5G network, which causes the AMF to deregister the UE. Subsequently, the UE may attempt to attach to another MME or one or of a Serving GPRS Support Node (SGSN), S4-SGSN, Visitor Location Register (VLR), resulting in one or more subsequent deregistration instructions that are each injected into the 5G network. Each deregistration instruction may be redundant and unnecessary for deregistering the UE from the 5GC, since the EU was already deregistered. The redundant deregistration instruction traffic exhausts computation resources and CPU cycle burn at the 5G to process and respond thereto according to the 5G standards, that could otherwise be used for distributing IP services to the UEs.

For 4G or 5G networking, when the user equipment (UE) operates in the dual registration mode, it is permitted to attach to and operate with a second MMD (or MME) when it is already attached to a first MMD or MME, or it can attach to a first MMD (or MME) when it is already attached to an access and mobility function (AMF). Similarly, when the UE is attached to an AMF and is in dual registration mode, it can attach to an MMD or MME, and so on. In particular, the relationship between MMD (or MME) and AMF allows AMF to replace the mobility management aspect of MMD (or MME) in 5G and acts as the access point to the 5G core. For the dual registration mode, the MME (AMF) sets a dual registration flag Dual-Registration-5G-Indicator to “1” (or “drFlag” value to “true”) in the MMD (or MME or AMF) registration message sent to HSS (or unified data management (UDM) that identifies the dual registration status of the UE. The HSS (UDM) will keep the UE registered in MMD (or MME) and AMF. For the UEs operating in the single registration mode, the MME (AMF) sets a dual registration flag Dual-Registration-5G-Indicator to “0” (or “drFlag” value to “false”) in the mobility management device (or AMF) registration message sent to HSS (or unified data management (UDM) that identifies the registration status of the UE.

In comparison, FIG. 4 illustrates a process that can optimize the deregistration of UEs operating in the single registration mode, for example, by implementing changes to MME/HSS in 4G and AMF/UDM/UDR in 5G (or other relevant types of telecommunications networks). For example, the MMEs may be changed/updated to actively alert the HSS (or the AMF to actively alert UDM) in order for the HSS (UDM) to send a deregistration instruction to the UDM (HSS) only when its necessary (e.g., based on the attachment status of the UE with the 5GC, where no additional deregistration instructions are needed for subsequent devices when the EU was already deregistered). This improvement can reduce the amount of traffic transmitted between HSS and UDM, because deregistration instructions will not be sent by the HSS when the UE does not need to be deregistered from a particular device (e.g., MME, AMF, etc.).

In this context, the N26 interface provides a communication channel between MME and AMF in accordance with the 3GPP specification. For example, the N26 interface can exchange the UE Mobility Management (MM) and Session Management (SM) states and help achieve network continuity as the UE moves from one network to another. The pre-existing N26 interface can be used to transmit messages between MME and AMF and reduce the redundant deregistration instructions.

In order to use this N26 interface feature, the UE is restricted to operating in the single registration mode. When in single registration mode, the UE may move from an AMF (MME) to an mobility management device, then attach to that MME (AMF). With the move, HSS (UDM) will deregister the previous AMF (MME). However, there are cases where no N26 interface is used, i.e., the UE is attached only to MME (AMF) and there is no previous AMF (MME).

To improve the deregistration process while the UE is operating in the single registration mode, a “new attribute” is defined. The new attribute may be named “singleRegIndication” attribute or a similar identifier with a corresponding attribute value that changes for different types of telecommunication networks.

For the MMD (or MME) registration in HSS, the “new attribute” is defined with the values “No Indication” and “Deregister AMF” to help reduce the traffic in this context. With the implementation of the new attribute, the mobility management device (MME) may continue to set a Dual-Registration-5G-Indicator value to “0” when the UE operates in single-registration mode. If there is no N26 interface connection to AMF, the MME may also set the new attribute to “No Indication”. Thus, HSS will not instruct UDM to deregister the AMF if there is an old mobility management device registration for which “No Indication” or “Deregister AMF” is indicated. Otherwise, the mobility management device sets the new attribute (singleRegIndication) to “Deregister AMF” with the Dual-Registration-5G-Indicator value to “0” when the UE operates in single-registration mode and the mobility management device has established a N26 interface connection to the old AMF that is registered in UDM. Thus, HSS will instruct UDM to deregister the AMF without the redundant and unnecessary deregistration instructions.

In another example, for AMF 3GPP access registration in UDM/UDR, the “new attribute” is defined with the values “NO_INDICATION” and “DEREGISTER_SN” to help reduce the traffic in this context. In some examples, the new attribute may be defined in a S6a Update Location Request. With the implementation of the new attribute (singleRegIndication), the AMF sets the drFlag value to “false” (or drFlag attribute is absent), which indicates that the UE operates in the single registration mode. The AMF also sets the new attribute (singleRegIndication) value to “NO_INDICATION” if there is no N26 interface connection to mobility management device. UDM is configured not to instruct HSS to cancel the MMD or MME (and SGSN/VLR) if there is an old AMF 3GPP registration for which “NO_INDICATION” or “DEREGISTER_SN” is indicated. Otherwise, the AMF sets the drFlag value to “false” (or drFlag to be absent) and sets the new attribute (singleRegIndication) to “DEREGISTER_SN” when the UE operates in single-registration mode and the AMF has established a N26 interface connection to the old MME. UDM can instruct HSS to cancel the MMD or MME (and SGSN/VLR). In addition, if the initial registration is also indicated in the new AMF 3GPP registration, UDM can instruct HSS to cancel the Serving GPRS Support Node (SGSN) procedures (e.g., configuration, cancelation, or other configuration instructions that enable the SGSN to function in GPRS (2.5G), UMTS (3G), or LTE (4G) networks).

For AMF 3GPP access registration with drFlag attribute set to false (or to be absent) in UDM/UDR, the AMF can set the new attribute (singleRegIndication) value to “NO_INDICATION” when there is no N26 interface connection to MME. UDM is configured to not instruct HSS to cancel MME (and SGSN/VLR) if there is an old AMF 3GPP registration for which “NO_INDICATION” or “DEREGISTER_SN” is set as the new attribute value (e.g., since the old AMF was already registered with the single registration). Otherwise, the AMF sets the new attribute (singleRegIndication) value to “DEREGISTER_SN” when the AMF has established a N26 interface connection to the old MME. UDM can instruct HSS to cancel the MME (and SGSN/VLR).

Accordingly, the systems and method disclosed herein can help optimize the deregistration of UE from the 5GC by avoiding unnecessary traffic generation, reducing CPU cycle burn, and avoiding burdening the 5GC via reduction and elimination of redundant message requests. Additionally, the systems and methods disclosed herein avoid burdening the EPC via reduction of redundant message requests by reducing the deregistration instructions transmitted in the telecommunication network. By reducing burdens to the 5GC and/or the EPC, response times can be improved and latency reduced.

An illustrative example of this process is shown in FIG. 4. In this example, the UE may operate in idle mode. These and other examples of the disclosure can implement the functionality while the UE is in idle mode or other connected mode (e.g., the UE having an internet connection), without diverting from the essence of the disclosure.

At block 410, the UE transmits a first registration request communication to a first AMF. For example, when a UE attempts to attach to the core network 130, the AMF serving the UE initiates a registration call flow to attach the UE to the core network 130. This call flow includes, among other functions and operations, requesting registration with the core network 130. For example, the call flow may include an identification of the UE (e.g., “ueld” as the IMSI).

At block 420, the context information is transmitted from the first AMF to the MME via the N26 interface. For example, the context request to the MME may include EPS GUTI mapped from 5G-GUTI and the TAU request message according to TS 23.401. In some examples, the MME may validate the TAU message. The MME can include EPS MM Context, IMSI, ME Identity, UE EPS security context, UE Network Capability, and EPS Bearer context(s) in the Context Response message and sends to the first AMF.

At block 430, the first AMF transmits a Nudm AMF 3GPP registration communication to UDM. In the communication, the drFlag value may be set to false, “0”, or the drFlag attribute may be absent associated with the single registration status of UE, as well as setting the value of the singleRegIndication attribute to “DEREGISTER_SN”.

At block 440, the UDM transmits a Nhss deregister-sn communication to HSS. By this point of the single registration example, the AMF node of a second type of telecommunication network receives a notification identifying that the UE has transmitted a registration request to the second type of telecommunication network from a MME node of a first type of telecommunication network. Due to “DEREGISTER_SN” value in the AMF 3GPP registration, the UDM node can then transmit a deregister-sn communication to the HSS node.

As discussed herein, the dual registration over multiple types of telecommunication networks may affect the deregistration process of the user equipment (UE). For example, when the UE is able to register with two types of telecommunication networks, it may not need to deregister from the first type of telecommunications network when it is moving to the second type of telecommunications network, and vice versa. However, in single registration mode, the UE may be able to register only with one type of telecommunication network at a time. As such, when the UE transmits the registration request for a second type of telecommunication network when it is already registered with a first type of telecommunication network, the described system may improve the deregistration process for the UE (and related devices) to help the UE deregister from the first type of telecommunication network.

In some examples, the drFlag attribute associated with the registration request of the UE operating in the single registration to the second type of telecommunication network is set to false or absent.

In some examples, receiving the deregistration instruction with the “deregister-sn” at the HSS node may initiate a deregistration process between the HSS and the MME node of the first type of telecommunication network. This may be based on the single registration mode of the UE.

At block 450, the HSS transmits a cancel location communication to MME. For example, the cancel location communication can correspond with a CLR with a Cancellation-Type of MME_UPDATE_PROCEDURE to the previous MME and replace the stored MME-Identity with the received value. In some examples, the HSS can reset the “UE purged in MME” flag and delete any stored last known MME location information of the (no longer) purged UE.

At block 460, the UE transmits a second registration request communication to a second AMF. The contents of the second registration request communication may be similar to the contents of the first registration request, but transmitted to the second AMF.

At block 470, the context information is transmitted from the first AMF to second AMF via the Namf comm context transfer operation using the POST command, as described herein.

At block 480, the second AMF transmits a Nudm AMF 3GPP registration communication to UDM. In the communication, the drFlag value may be set to “false” or the drFlag attribute may be absent associated with the single registration status of UE, as well as setting the value of the singleRegIndication attribute to “NO_INDICATION” since there is no N26 interface. Because the first AMF is registered with “DEREGISTER_SN” indicating that MME has been deregistered, the UDM does not transmit a deregister-sn communication to the HSS.

An illustrative process of a UE moving from a first location to a second location and operating in a single registration mode in 5GC with the use of the N26 interface is illustrated in FIG. 5. The devices illustrated in FIG. 5 may be substantially similar to the devices illustrated in FIG. 1 and discussed throughout the disclosure, including UE 104, MME 122, AMF 132, UDM 150, and HSS 140.

In this example, the UE in shown in idle mode. These and other examples of the disclosure can implement the functionality while the UE is in idle mode or other connected mode (e.g., the UE having an internet connection), without diverting from the essence of the disclosure.

As discussed herein, in order to use this “new attribute” or singleRegIndication attribute (used interchangeably) in conjunction with the N26 interface feature, the UE is restricted to operating in the single registration mode. When in single registration mode, the UE will move from an MME to a first AMF, then attach to that AMF. With the move, UDM will deregister the previous MME. The singleRegIndication attribute may identify if there is a N26 interface between the AMF and the MME. For example, the AMF sets a drFlag value to “false” or the drFlag attribute may be absent indicating that the UE operates in single-registration mode. If there is no N26 interface connection to MME, the AMF sets the singleRegIndication attribute to “NO_INDICATION”. UDM will not instruct HSS to deregister the AMF if there is an old mobility management device (AMF) registration for which “NO_INDICATION” or “DEREGISTER_SN” is indicated. Otherwise, the AMF sets the singleRegIndication attribute to “DEREGISTER_SN” when the MME has established a N26 interface connection to the AMF that is registered in UDM. UDM will instruct HSS to deregister the MME.

At block 505, the UE transmits a first registration request communication to a first AMF. The first registration request may be transmitted while the UE operates in single registration model. For example, the first registration request may correspond with the UE moving within a proximity distance of the first AMF.

At block 510, the context information is transmitted to the first AMF from the first MME via the N26 interface.

At block 515, the first AMF transmits a Nudm AMF 3GPP registration communication to UDM. In the communication, the drFlag attribute may be absent or the drFlag value may be set to false and the singleRegIndication attribute may be set to “DEREGISTER_SN”.

At block 520, the UDM transmits a Nhss deregister-sn communication to HSS. As discussed herein, using this deregistration instruction (e.g., deregister-sn), the UDM instructs the HSS to cancel the first MME.

At block 525, the HSS transmits a cancel location communication to the first MME (e.g., using the CLR or other methods discussed herein).

At block 530, the UE operating in the dual registration mode establishes a registration/attachment with the second MME (with HSS) The second MME transmits an update location communication to HSS by setting the “Dual-Registration-5G-Indicator” bit to 1 instead of 0”. In doing so, the UE is dual-registered with the second MME (with HSS) and the first AMF (with UDM), in response to the first registration request communication in block 505. As such, the HSS does not instruct the UDM to deregister the first AMF.

At block 535, the UE transmits a second registration request communication to a second AMF. The second registration request may be transmitted in association with a single registration mode. The contents of the registration request communication may be defined in the 3GPP specification and as described herein.

At block 540, the context information is transmitted to the second AMF from the second MME via the N26 interface. For example, the context request to the second MME may include EPS GUTI mapped from 5G-GUTI and the TAU request message according to TS 23.401, or other information as described herein.

At block 545, the context information is transmitted from the first AMF to second AMF via the Namf comm context transfer operation using the POST command, as described herein.

At block 550, the second AMF transmits a Nudm AMF 3GPP registration communication to UDM. In the communication, the drFlag attribute may be absent or the drFlag value may be set to false and the singleRegIndication attribute may be set to “DEREGISTER_SN”.

At block 555, the UDM (optionally) transmits a Nhss deregister-sn communication to HSS. For example, the first AMF may be registered with “DEREGISTER_SN” indicating that MME has been deregistered and the deregister-sn communication may or may not be transmitted to the HSS.

At block 560, the HSS transmits a cancel location communication to the second MME. For example, the cancel location communication can correspond with a CLR with a Cancellation-Type of MME_UPDATE_PROCEDURE to the previous MME and replace the stored MME-Identity with the received value. In some examples, the HSS can reset the “UE purged in MME” flag and delete any stored last known MME location information of the (no longer) purged UE.

In other words, based on the presence of the singleRegIndication attribute, when the UE moves with the single registration mode to the second AMF from the MME (block 535), the second AMF creates a N26 connection to the MME (block 540). Then, the second AMF registers itself with “DEREGISTER_SN” in UDM (block 545). This causes UDM to instruct HSS to deregister MME (block 555), regardless of the registration mode of the first AMF. As a comparison with FIG. 4, when “NO_INDICATION” is received from the second AMF, UDM does not instruct HSS to deregister MME if the first AMF indicates “NO_INDICATION” or “DEREGISTER_SN”. This is because the MME was already deregistered.

It should be noted that the terms “optimize” and “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

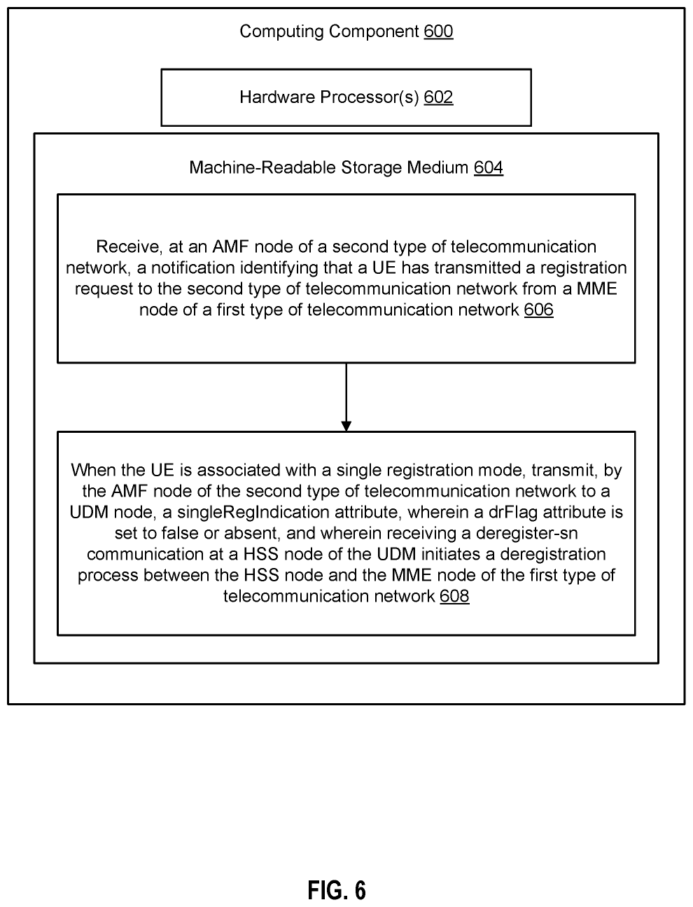

FIG. 6 is an example computing component 600 that may be used to implement various features of the elements, network functions, etc. illustrated in any of FIGS. 1-5 in accordance with one embodiment of the disclosed technology. Computing component 600 may be, for example, a server computer, a controller, or any other similar computing component capable of processing data. In the example implementation of FIG. 6, the computing component 600 includes a hardware processor 602, and machine-readable storage medium 604.

Hardware processor 602 may be one or more central processing units (CPUs), semiconductor-based microprocessors, and/or other hardware devices suitable for retrieval and execution of instructions stored in machine-readable storage medium 604. Hardware processor 602 may fetch, decode, and execute instructions, such as instructions 606 and 608, to control processes or operations for determining UE slice accessibility. As an alternative or in addition to retrieving and executing instructions, hardware processor 602 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 604, may be any electronic, magnetic, optical, or other physical storage device that contains or stores executable instructions. Thus, machine-readable storage medium 604 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 604 may be a non-transitory storage medium, where the term “non-transitory” does not encompass transitory propagating signals. As described in detail below, machine-readable storage medium 604 may be encoded with executable instructions, for example, instructions 606 and 608.

Hardware processor 602 may execute instruction 606 to receive, at an AMF node of a second type of telecommunication network, a notification identifying that a UE has transmitted a registration request to the second type of telecommunication network from a MME node of a first type of telecommunication network. For example, the first network may be a 4G/LTE network and the second network may be a 5G network, as set forth above. As the UE moves out of the second network, the UE attempts to attach to the first network, which causes a first mobility management device (e.g., one of a MME, S4-SGSN, SGSN, or VLR) to issue an Update Location Request (ULR), for example, to an HSS, as discussed in connection with FIG. 3. Based on this request, processor 602 may execute instructions 606 to receive a notification identifying that the UE has transmitted the registration request to join a different network type.

Hardware processor 602 may execute instruction 608 to transmit a singleRegIndication attribute introduced in the registration request of the AMF node by the AMF node to the UDM node. For example, various conditions may apply. In some examples, a drFlag attribute associated with the registration request of the AMF/UE to the second type of telecommunication network is set to false or absent. In some examples, receiving a deregister-sn communication at the HSS node from the UDM initiates a deregistration process between the HSS and the MME node of the first type of telecommunication network.

In some examples, the transmitting of the deregister-sn communication from a UDM node may only be performed if there is an N26 connection between the MME node of the first type of telecommunication network and the AMF node of the second type of telecommunication network or the singleRegIndication attribute with the value of “deregister-sn” has not been transmitted.

In some examples, when the UE is associated with a single registration mode and one or more of these conditions are present, the AMF node may transmit the singleRegIndication attribute with the value of “deregister-sn” to a UDM node of the second type of telecommunication network, which is then transmitted to an HSS node. The drFlag attribute associated with the registration request of the UE to the second type of telecommunication network may be set to false or may be absent. Additionally, when the deregister-sn communication is received at the HSS node, receiving the singleRegIndication attribute may initiate a deregistration process between the HSS and the MME node of the first type of telecommunication network.

Computing components and devices, such as computing component 600, may include a main memory, such as a RAM, cache and/or other dynamic storage devices, coupled to a bus for storing information and instructions to be executed by a processor of the computing component or devices. The main memory also may be used for storing temporary variables or other intermediate information during execution of instructions to be executed by the processor, for example, as described above in connection with FIG. 6. Such instructions, when stored in storage media accessible to the processor, render computer component into a special-purpose machine that is customized to perform the operations specified in the instructions.

The computing components and devices may further include a read only memory (ROM) or other static storage device coupled to the bus for storing static information and instructions for the processor. A storage device, such as a magnetic disk, optical disk, or USB thumb drive (Flash drive), etc., may be provided and coupled to the bus for storing information and instructions.

In general, the words “component”, “engine”, “system”, “database”, “data store”, and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computing components and devices may implement the techniques described herein using customized hard-wired logic, one or more ASICs or FPGAs, firmware and/or program logic which in combination with the computing component causes or programs the computing component to be a special-purpose machine. According to one embodiment, the techniques herein are performed by the computing components and devices in response to processor(s) executing one or more sequences of one or more instructions contained in the main memory. Such instructions may be read into the main memory from another storage medium. Execution of the sequences of instructions contained in the main memory causes the processor(s) to perform the process steps described herein. In alternative embodiments, hard-wired circuitry may be used in place of or in combination with software instructions.

The term “non-transitory media” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks. Volatile media includes dynamic memory, such as the main memory. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise the bus. Transmission media can also take the form of acoustic or light waves, such as those generated during radio-wave and infra-red data communications.

The computing components and devices may also include a network interface coupled to the bus. The network interface provides a two-way data communication coupling to one or more network links that are connected to one or more local networks. For example, the network interface may be an integrated services digital network (ISDN) card, cable modem, satellite modem, or a modem to provide a data communication connection to a corresponding type of telephone line. As another example, the network interface may be a local area network (LAN) card to provide a data communication connection to a compatible LAN (or WAN component to communicated with a WAN). Wireless links may also be implemented. In any such implementation, the network interface sends and receives electrical, electromagnetic or optical signals that carry digital data streams representing various types of information.

A network link typically provides data communication through one or more networks to other data devices. For example, a network link may provide a connection through local network to a host computer or to data equipment operated by an Internet Service Provider (ISP). The ISP in turn provides data communication services through the world wide packet data communication network now commonly referred to as the “Internet”. Local network and Internet both use electrical, electromagnetic or optical signals that carry digital data streams. The signals through the various networks and the signals on network link and through the network interface, which carry the digital data to and from computing components and devices, are example forms of transmission media.

The computing components and devices can send messages and receive data, including program code, through the network(s), network link and the network interface. In the Internet example, a server might transmit a requested code for an application program through the Internet, the ISP, the local network and the network interface.

The received code may be executed by the processor as it is received, and/or stored in the storage device, or other non-volatile storage for later execution.

Each of the processes, methods, and algorithms described in the preceding sections may be embodied in, and fully or partially automated by, code components executed by one or more computer systems or computer processors comprising computer hardware. The one or more computer systems or computer processors may also operate to support performance of the relevant operations in a “cloud computing” environment or as a “software as a service” (SaaS). The processes and algorithms may be implemented partially or wholly in application-specific circuitry. The various features and processes described above may be used independently of one another, or may be combined in various ways. Different combinations and sub-combinations are intended to fall within the scope of this disclosure, and certain method or process blocks may be omitted in some implementations. The methods and processes described herein are also not limited to any particular sequence, and the blocks or states relating thereto can be performed in other sequences that are appropriate, or may be performed in parallel, or in some other manner. Blocks or states may be added to or removed from the disclosed example embodiments. The performance of certain of the operations or processes may be distributed among computer systems or computers processors, not only residing within a single machine, but deployed across a number of machines.

As used herein, a circuit might be implemented utilizing any form of hardware, software, or a combination thereof. For example, one or more processors, controllers, ASICs, PLAs, PALs, CPLDs, FPGAs, logical components, software routines or other mechanisms might be implemented to make up a circuit. In implementation, the various circuits described herein might be implemented as discrete circuits or the functions and features described can be shared in part or in total among one or more circuits. Even though various features or elements of functionality may be individually described or claimed as separate circuits, these features and functionality can be shared among one or more common circuits, and such description shall not require or imply that separate circuits are required to implement such features or functionality. Where a circuit is implemented in whole or in part using software, such software can be implemented to operate with a computing or processing system capable of carrying out the functionality described with respect thereto.

As used herein, the term “or” may be construed in either an inclusive or exclusive sense. Moreover, the description of resources, operations, or structures in the singular shall not be read to exclude the plural. Conditional language, such as, among others, “can”, “could”, “might”, or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. Adjectives such as “conventional”, “traditional”, “normal”, “standard”, “known”, and terms of similar meaning should not be construed as limiting the item described to a given time period or to an item available as of a given time, but instead should be read to encompass conventional, traditional, normal, or standard technologies that may be available or known now or at any time in the future. The presence of broadening words and phrases such as “one or more”, “at least”, “but not limited to”, or other like phrases in some instances shall not be read to mean that the narrower case is intended or required in instances where such broadening phrases may be absent.

What is claimed is:

1. A non-transitory computer-readable storage medium storing a plurality of instructions executable by one or more processors, the plurality of instructions when executed by the one or more processors cause the one or more processors to:
receive, at an Access and Mobility Management Function (AMF) node of a second type of telecommunication network, a notification identifying that a User Equipment (UE) has transmitted a registration request to the second type of telecommunication network from a Mobility Management Entity (MME) node of a first type of telecommunication network; and
when the UE is in a single registration mode, transmit, by a Access and Mobility Management Function (AMF) node of the second type of telecommunication network to a Unified Data Management (UDM) node, a singleRegIndication attribute associated with the UE,
wherein a drFlag attribute associated with the registration request of the AMF node to the second type of telecommunication network is set to false or absent, and
wherein the transmitting of the singleRegIndication attribute between the AMF node and the MME node enables receiving a deregister-sn communication at a Home Subscriber Server (HSS) node from the UDM initiates a deregistration process between the HSS node and the MME node of the first type of telecommunication network.

2. The non-transitory computer-readable storage medium of claim 1, wherein the singleRegIndication attribute is introduced in the registration request of the AMF node.

3. The non-transitory computer-readable storage medium of claim 1, wherein the transmitting of the deregister-sn communication is performed if there is a N26 connection between the MME node of the first type of telecommunication network and the AMF node of the second type of telecommunication network.

4. The non-transitory computer-readable storage medium of claim 1, wherein the transmitting of the deregister-sn communication is performed only if the deregister-sn communication has not previously been transmitted in association with the UE.

5. The non-transitory computer-readable storage medium of claim 1, wherein the singleRegIndication attribute is set to the value of “DEREGISTER_SN” or “NO_INDICATION”.

6. The non-transitory computer-readable storage medium of claim 1, wherein the context information may be transmitted to the second type of telecommunication network from the first type of telecommunication network via an N26 interface.

7. The non-transitory computer-readable storage medium of claim 1, wherein the registration request is automatically transmitted for updating a location of the UE as the UE moves from the first type of telecommunication network to the second type of telecommunication network.

8. The non-transitory computer-readable storage medium of claim 1, wherein a deregistration instruction is not transmitted based on a determination that the UE is attached to another MME node prior to receiving connectivity information associated with the registration request.

9. The non-transitory computer-readable storage medium of claim 1, wherein the UE moves from a 4G/LTE cellular network of the first type of telecommunication network to a 5^{th} generation (5G) cellular network of the second type of telecommunication network.

10. The non-transitory computer-readable storage medium of claim 1, wherein the HSS node is configured to send a cancel location message to the MME node.

11. The non-transitory computer-readable storage medium of claim 1, wherein:
the first type of telecommunication network is a 4G cellular network and the second type of telecommunication network is a 5^{th} generation (5G) cellular network,
the deregistration process transmits a second deregistration instruction corresponding with a deregister-sn communication to the HSS node of the first type of telecommunication network from the UDM node,
the HSS node causes a Core Access and Mobility Management Entity (MME) node of the first type of telecommunication network to deregister the UE from the first type of telecommunication network, and
in response to a determination that the UE is not attached to another MME node, the UDM node does not transmit a third deregistration instruction to the HSS node to initiate a deregistration process of the UE from the first type of telecommunication network.

12. The non-transitory computer-readable storage medium of claim 1, wherein the one or more processors further to:
determine that the UE is not attached to another MME node by:
receiving the singleRegIndication attribute with a value of “NO_INDICATION”, and
identifying from an old AMF registration that the UE is operating in the single registration mode of the second type of communication network with the singleRegIndication attribute having a value of “NO_INDICATION” or “DEREGISTER_SN” or with a value of the drFlag attribute set to false or the drFlag attribute being absent.

13. A method comprising:
receiving, at an Access and Mobility Management Function (AMF) node of a second type of telecommunication network, a notification identifying that a User Equipment (UE) has transmitted a registration request to the second type of telecommunication network from a Mobility Management Entity (MME) node of a first type of telecommunication network; and
when the UE is associated with a single registration mode, transmitting, by a Access and Mobility Management Function (AMF) node of the second type of telecommunication network to a Unified Data Management (UDM) node, a singleRegIndication attribute introduced in the registration request of the AMF node,
wherein a drFlag attribute associated with the registration request of the AMF node to the second type of telecommunication network is set to false or absent, and
wherein the transmitting of the singleRegIndication attribute between the AMF node and the MME node enables receiving a deregister-sn communication at a Home Subscriber Server (HSS) node from the UDM node initiates a deregistration process between the HSS node and the MME node of the first type of telecommunication network.

14. The method of claim 12, wherein the transmitting of the deregister-sn communication is performed only if there is N26 connection between the MME node of the first type of telecommunication network and the AMF node of the second type of telecommunication network.

15. The method of claim 12, wherein the transmitting of the deregister-sn communication is performed only if the deregister-sn communication has not previously been transmitted in association with the UE.

16. The method of claim 12, wherein the singleRegIndication attribute is set to the value of “DEREGISTER_SN” or “NO_INDICATION”.

17. The method of claim 12, wherein the context information may be transmitted to the second type of telecommunication network from the first type of telecommunication network via an N26 interface.

18. The method of claim 12, wherein the registration request is automatically transmitted for updating a location of the UE as the UE moves from the first type of telecommunication network to the second type of telecommunication network.

19. The method of claim 12, wherein a deregistration instruction is not transmitted based on a determination that the UE is not attached to another MME node prior to receiving connectivity information associated with the registration request.

20. An Access and Mobility Management Function (AMF) node of a second type of telecommunication network, the AMF node comprising:
a memory; and
one or more processors that are configured to execute machine readable instructions stored in the memory for performing the method comprising:
receiving a notification identifying that a User Equipment (UE) has transmitted a registration request to the second type of telecommunication network from a Mobility Management Entity (MME) node of a first type of telecommunication network; and
when the UE is associated with a single registration mode, enabling a transmission by a Access and Mobility Management Function (AMF) node of the second type of telecommunication network to a Unified Data Management (UDM) node, a singleRegIndication attribute associated with the UE,
wherein a drFlag attribute associated with the registration request of the AMF to the second type of telecommunication network is set to false or absent, and
wherein the transmitting of the singleRegIndication attribute between the AMF node and the MME node enables receiving a deregister-sn communication at a Home Subscriber Server (HSS) node from the UDM initiates a deregistration process between the HSS node and the MME node of the first type of telecommunication network.
